(19) United States
(12) Patent Application Publication
(10) Pub. No.: US 2006/0025137 A1
(43) Pub. Date: Feb. 2, 2006

(54) Mobile radio communications device and method of transferring between networks therefor

(75) Inventor: Richard Ormson, Berkshire (GB)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/193,461

(22) Filed: Aug. 1, 2005

(30) Foreign Application Priority Data
Aug. 2, 2004 (GB) 0417198.9

(51) Int. Cl. H04Q 7/20; H04M 1/00; H04B 1/38

(52) U.S. Cl. 455/436

(57) ABSTRACT

The present invention provides for a method of transferring operation of a mobile radio communication device from a first network to a second network, while connected to the said first network, and including the steps of identifying cells of the said second network, comparing signal power level of the identified cells with a threshold level and connecting to a cell of the second network identified as having a signal power level above the said threshold level such that that passage can be transferred from, for example, a 3G network to a 2G network can be achieved without requiring the 3G network to monitor the 2G network prior to such handover.

### BACKGROUNDS OF THE INVENTION

1. Field of the Invention

The present invention relates to a method of transferring operation of a handset from a first network to a second network, and to a related handset.

2. Description of the Related Art

When employing a handset offering at least dual mode operability, situations can commonly arise requiring that the handset transfer its operation from a first network to a second network.

For example, for cell phones offering third generation (3G) operability by way of a UMTS connection, and second generation (2G) operability by way of a GSM connection, a requirement can commonly arise for the cell phone to conduct a handover or reselection from a UMTS cell to a GSM cell.

In accordance with the current state of the art, and indeed in accordance with current standards, a transfer from a UMTS network to a GSM network generally requires that the GSM cells in the vicinity of cell phone handset be monitored while the handset is operating on the 3G UMTS network.

Disadvantages and limitations arise however in relation to such handovers in view of resulting Software complications. A requirement to generate gaps in the operation on the 3G UMTS network connection also arises, and as archived in the so-called compressed mode of operation.

Thus, within the current state of the art, when it is required to hand-off a call from 3G UMITS network, for example for coverage or load balancing reasons, the above-mentioned problems and limitations can disadvantageously arise.

### SUMMARY OF THE INVENTION

The present invention seeks to provide for a method of transferring operation of a handset from a first network to a second network, and to a related handset, having advantages over known such methods and devices.

According to one aspect of the present invention, there is provided a method of transferring operation of a mobile radio communications device from a first network to a second network, while connected to the said first network, and including the steps of:
identifying cells of the said second network;
comparing signal power level of the identified cells with a threshold level; and
connecting to a cell of the second network identified as having a signal power level above the said threshold level.

The invention is particularly advantageous in allowing for handover between a first network and a second network but which does not require monitoring of the said second network whilst the said first network is in use.

In particular, and as compared with the state of the art. the actual selection of the relevant cell to which the device is to achieve handover is performed as the first stage of the handover procedure.

Network handover can therefore advantageously be supported without requiring monitoring of the network to which connections is to be made. Also it proves possible to remove the requirement for compressed mode operation within a 3G mobile telecommunication system.

Advantageously, the method includes the steps of connecting to the first of the said cells of the second network identified as having a signal power level above the threshold.

Further, the comparison step comprises a search for a BTS channel with a received signal above the said threshold level.

In one arrangement, the cells of the said second network are identified by way of call control data received as part of the signal information on the said first network.

Also, the said threshold level can advantageously be set by way of network messaging of the said first network.

Advantageously, the method further includes the step of providing positional information from the handset serving to assist with identification of cells of the second network.

Alternatively, or in addition, the method can include the step of forwarding from the handset identification of the particular cell to which connection is to be made.

Preferably, such identification can be provided by way of an Inter RAT measurement report.

In particular, the method can be provided for transferring operation of the handset from a 3G network to 2G network.

According to another aspect of the present invention, there is provided a mobile radio communications device arranged for operation with a first network and a second network and for transferring connectivity from the said first network to the said second network while connected to the said first network, the device including means arranged to identify cells of the said second network, means for comparing signal power levels of the identified cells with a threshold level, and means arranged to connect the device to a cell of the said second network and which is identified as having a signal power level above the said threshold level.

As will be appreciated from the above, such a handset can provide for the advantages of the method as defined above.

Thus, the device can advantageously be arranged to connect to the first of the cells of the second network identified as having a signal power level above the said threshold.

Also, the said means for comparing can be arranged for searching for a BTS channel with a received signal strength above the said threshold revel.

Further, the device is advantageously arranged to receive call control data by way of the said first network and which can serve to identify the said cells of the said second network.

Yet further, the device is advantageously arranged to have the said threshold level set by means of first network messaging signals.

Also, the device can be arranged to provide for positional information serving to assist in the identification of the cells of the said second network.

Yet further, the device can advantageously be arranged to generate and transmit a report identifying the cell of the second network to which connection is to be made.

Advantageously, the said report can be provided by way of an Inter RAT measurement report.

in particular, the device is arranged so as to provide for transfer from a 3G network to a 2G network.

### BRIEF DESCRIPTION OF THE DRAWINGS

The invention is described further hereinafter, by way of example only, with reference to the accompanying drawings in which:

FIG. 1 is a schematic diagram of a handset embodying the present invention; and

FIG. 2 is a flow diagram serving to illustrate the method steps of a method embodying the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

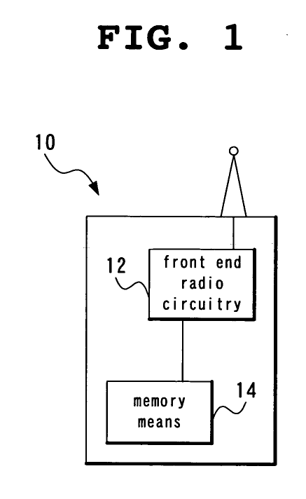

Turning first to FIG. 1, there is illustrated a diagram of a mobile radio communications device handset 10 arranged for operation in accordance with the present invention.

The handset 10 comprises front end radio circuitry 12 and processing and memory means 14 connected thereto for controlling the operation thereof, and for receiving data therefrom.

The memory processing means 14 is arranged to conduct the reference to the 2G neighbour list and to conduct the search for the first of the cells within that list having a BTS channel exhibiting a received signal strength above a certain threshold value.

As discussed, the particular threshold value can be set remotely by way of network signaling received at the handset.

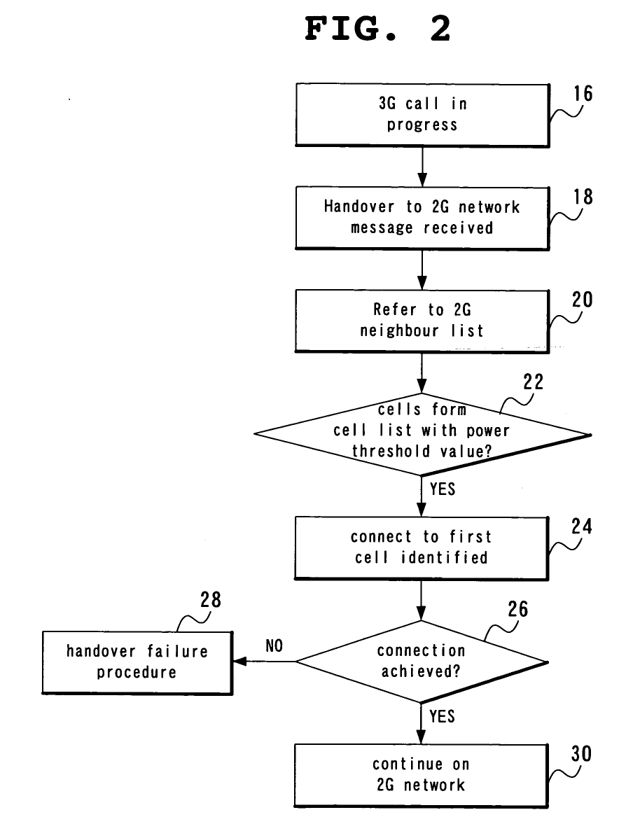

Thus, and as will be described in further detail with reference to FIG. 2, the handset 10, while connected to a 3G.network, and upon receipt of a handover message requiring handover to a 2G network, can conduct an accelerated search in order to identify a likely appropriate cell of the 2G network to connect to and without requiring ongoing monitoring of the 2G network whilst operating on the 3G network.

In considering the example illustrated with reference to FIG. 2, it should be appreciated that, as noted, the handset is arranged to connect to both a 3G and a 2G network. However, when operating in accordance with the 3G network, and without the above-mentioned compressed mode of operation, it is not possible to monitor activity on one network while connected to the other. Also, it should be assumed that a call is in progress on the 3G network as illustrated at 16.

As noted above, for reasons of network coverage or for load balancing etc. it can often be required for the 3G network to hand-off the call to a 2G network. In order to achieve this, the 3G network sends a handover message 18 to the handset.

In accordance with standards arising in the current state of the art, such a handover message would indicate the 2G Absolute Radio Frequency Channel Number (ARFCN) to which the handset should move its connection. The choice of the actual ARFCN employed is based upon monitor reports that the handset has previously sent to the 3G network.

However, in accordance with the present invention, it should be appreciated that the handset is not arranged for, nor does it necessarily have the ability for, monitoring activity on the other network such that a preferred cell cannot then be identified within the handover message. A relevant field is therefore not included within such a handover message or the field can include a dummy value.

The handset can now enter a variant of the known blind handover procedure. Such known blind handover procedure is defined in current standards to allow a handset to connect to a cell that it has been monitoring but to which it is not currently synchronized. For such known blind handovers, the UTRAN system is generally informed of a suitable candidate from the neighbouring cells so as to execute a handover without requiring the specific user equipment measurements.

In accordance with the current standards, such known blind handover procedures are allowed 140 ms in order to complete.

Returning to the illustrated embodiment of the present invention, the handset first refers to the 2G neighbour list at step 20 that it receives as part of standard call control messaging on the 3G network and then executes an accelerated search mechanism according to the present invention.

At steps 22 and 24, the handset effectively seeks to identify a cell from the cell list having a power level above a determined threshold level and to connect to the first cell so identified as exhibiting a power level above the said threshold level. Thus, the step of connecting to a desired cell is undertaken once that cell has been identified as the first exhibiting the appropriate power level and before searches against other cells have been conducted.

Should no such connection be achieved, the process can proceed by way of a handover failure procedure as indicated at step 24.

However, if successful, the connection continues on the 2G networks as indicated at step 30.

In particular, and within the accelerated search, of the present invention the handset simply searches for the first BTS channel at step 24 exhibiting a received signal strength above the said threshold value and then seeks to connect to that BTS channel.

Advantages arise since, as compared with the standard blind handover, the selection of the relevant cell is performed at the first stage of the handover procedure. This means that, unlike blind handover, the handset cannot attempt handover to a cell it cannot receive.

To illustrate the example further, it is assumed that the maximum number of neighbouring cells allowed within a neighbour cell list is thin-two, and that the only usable cell is the last found on that list. Then a search to identify that cell will take approximately 12 ms (i.e. 32×350 us) given that a search of each cell takes 350 us.

It will be clear however that, in most cases, the time taken to complete the search would be considerably less as the number of neighbouring cells rarely reaches thin-two. Also, on average, generally at least half of the cells on the list are usable due to geographical distribution of the cells. Thus, on average, the search would be successful after two measurements, which would therefore require an average overall search time of less that 1 ms.

This quite readily sits within the tolerance allowed under existing 3GPP blind handover mechanisms.

Turning now to the network arrangement, it win of course be appreciated that the network is no longer provided with identification of the cell to which the handset will be moving to. While it will be possible to revise network signalling so as to allow for movement to any of the defined neighbours, this might not be seen as the most appropriate solution.

Thus, if the handset supports positioning functionality, the number of potential cells to which connection would be made can advantageously be reduced through such positional information. Alternatively, the handset can be arranged to send a report following the 2G search so as to indicate to which cell the handset will be moving to.

Advantageously such information can readily be provided by way of an existing message such as the inter RAT measurement report.

To summarise therefore, the invention advantageously provides a mechanism which allows for handover from a 3G network to a 2G network to be supported without requiring monitoring of the 2G network, nor support of compressed mode.

such an handover can advantageously be achieved employing currently existing air interface messaging and with minimal changes required to the network.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A method of transferring operation of a mobile radio communications device from a first network to a second network, while connected to the said first network, and including the steps of:
identifying cells of the said second network;
comparing signal power level of the identified cells with a threshold level; and
connecting to a cell of the second network identified as having a signal power level above the said threshold level.

2. A method as set forth in claim 1, further including the step of
connecting to the first of the said cells of the second network identified as having a signal power level above the threshold.

3. A method as set forth in claim 1, wherein the said threshold level can advantageously be set by way of network messaging of the said first network.

4. A method as set forth in claim 1, further including the step of
connecting to the first of the said cells of the second network identified as having a signal power level above the threshold,
wherein the said threshold level can advantageously be set by way of network messaging of the said first network.

5. A method as set forth in claim 1, further including the step of providing positional information from the device and serving to assist with identification of cells of the second network.

6. A method as set forth in claim 11, further including the steps of
connecting to the first of the said cells of the second network identified as having a signal power level above the threshold, and
providing positional information from the device and serving to assist with identification of cells of the second network.

7. A method as set forth in claim 1, further including the step of providing positional information from the device and serving to assist with identification of cells of the second network,
wherein the said threshold level can advantageously be set by way of network messaging of the said first network.

8. A method as set forth in claim 1, further including the steps of
connecting to the first of the said cells of the second network identified as having a signal power level above the threshold, and
providing positional information from the device and serving to assist with identification of cells of the second network,
wherein the said threshold level can advantageously be set by way of network messaging of the said first network.

9. A method as set forth in claim 1, wherein
selection of the cell to which the device is to achieve handover is performed as the first stage of the handover procedure.

10. A method as set forth in claim 1, further including the step of
connecting to the first of the said cells of the second network identified as having a signal power level above the threshold,
wherein selection of the cell to which the device is to achieve handover is performed as the first stage of the handover procedure.

11. A method as set forth in claim 1, wherein the said threshold level can advantageously be set by way of network messaging of the said first network, and
selection of the cell to which the device is to achieve handover is performed as the first stage of the handover procedure.

12. A method as set forth in claim 1, further including the step of providing positional information from the device and serving to assist with identification of cells of the second network,
wherein selection of the cell to which the device is to achieve handover is performed as the first stage of the handover procedure.

13. A mobile radio communications device arranged for operation with a first network and a second network and for transferring connectivity from the said first network to the said second network while connected to the said first network, the device including means arranged to identify cells of the said second network, means for comparing signal power levels of the identified cells with a threshold level, and means arranged to connect the device to a cell of the said second network and which is identified as having a signal power level above the said threshold level.

14. A device as set forth in claim 13, further arranged to connect to the first of the cells of the second network identified as having a signal power level above the said threshold.

15. A device as set forth in claim 13, wherein the means for comparing is arranged for searching for a BTS channel with a received signal strength above the said threshold level.

16. A device as set forth in claim 13, further arranged to connect to the first of the cells of the second network identified as having a signal power level above the said threshold,
wherein the means for comparing is arranged for searching for a BTS channel with a received signal strength above the said threshold level.

17. A device as set forth in claim 13, further arranged to receive call control data by way of the said first network and which serves to identify the said cells of the said second network.

18. A device as set forth in claim 13, further arranged to connect to the first of the cells of the second network identified as having a signal power level above the said threshold, and
arranged to receive call control data by way of the said first network and which serves to identify the said cells of the said second network.

19. A device as set forth in claim 13, further arranged to receive call control data by way of the said first network and which serves to identify the said cells of the said second network,
wherein the means for comparing is arranged for searching for a BTS channel with a received signal strength above the said threshold level.

20. A device as set forth in claim 13, further arranged to connect to the first of the cells of the second network identified as having a signal power level above the said threshold, and
arranged to receive call control data by way of the said first network and which serves to identify the said cells of the said second network,
wherein the means for comparing is arranged for searching for a BTS channel with a received signal strength above the said threshold level.

21. A device as set forth in claim 13, further arranged to have the said threshold level set by means of first network messaging signals.

22. A device as set forth in claim 13, further arranged to connect to the first of the cells of the second network identified as having a signal power level above the said threshold, and
arranged to have the said threshold level set by means of first network messaging signals.

23. A device as set forth in claim 13, further arranged to have the said threshold level set by means of first network messaging signals,
wherein the means for comparing is arranged for searching for a BTS channel with a received signal strength above the said threshold level.

24. A device as set forth in claim 13, further arranged to receive call control data by way of the said first network and which serves to identify the said cells of the said second network, and
arranged to have the said threshold level set by means of first network messaging signals.

25. A device as set forth in claim 13, further arranged to generate and transmit a report identifying the cell of the second network to which connection is to be made.

26. A device as set forth in claim 13, further arranged to connect to the first of the cells of the second network identified as having a signal power level above the said threshold, and
arranged to generate and transmit a report identifying the cell of the second network to which connection is to be made.

27. A device as set forth in claim 13, further arranged to generate and transmit a report identifying the cell of the second network to which connection is to be made,
wherein the means for comparing is arranged for searching for a BTS channel with a received signal strength above the said threshold level.

28. A device as set forth in claim 13, further arranged to receive call control data by way of the said-first network and which serves to identify the said cells of the said second network, and
arranged to generate and transmit a report identifying the cell of the second network to which connection is to be made.

29. A device as set forth in claim 13, further arranged to have the said threshold level set by means of first network messaging signals, and
arranged to generate and transmit a report identifying the cell of the second network to which connection is to be made.

30. A device as set forth in claim 13, further arranged to generate and transmit a report identifying the cell of the second network to which connection is to be made,
wherein the said report can be provided by way of an Inter RAT measurement report.
